(19) United States
(12) Patent Application Publication
(10) Pub. No.: US 2019/0163724 A1
(43) Pub. Date: May 30, 2019

(54) SYSTEM AND METHOD FOR GENERATING AND MODIFYING CONTENT FOR AN LED SIGN

(71) Applicant: Next LED Signs, LLC, Wichita, KS (US)

(72) Inventors: Luke D. Luttrell, WICHITA, KS (US); Lucas L. Clupny, WICHITA, KS (US); Brett A. Wright, WELLINGTON, KS (US); Brady Haag, WICHITA, KS (US)

(73) Assignee: Next LED Signs, LLC, WICHITA, KS (US)

(21) Appl. No.: 15/825,999

(22) Filed: Nov. 29, 2017

(51) Int. Cl. G06F 17/21; G06F 17/30; G06F 17/24; G06T 3/40; G09G 5/373

(52) U.S. Cl. CPC G06F 17/212; G06F 17/30572; G06F 17/30864; H04M 1/72561; G06T 3/40; G09G 5/373; G06F 17/248

(57) ABSTRACT

A system and method for generating and modifying content for an LED sign comprising a database, a host server coupled to the database, and a processing element coupled to the host server. The database has a plurality of templates stored thereon, with at least one template having a plurality of versions, wherein each version has a different aspect ratio. The host server is configured to host a website on which it displays the plurality of templates. The host server is configured to receive via the website the user's selected template and the dimensions of the LED sign. The host server is configured to send the selected template and dimensions to the processing element. The processing element is configured to determine an optimum version of the selected template based on the dimensions of the LED sign. The processing element is configured to crop and size the optimum version to match the dimensions of the LED sign thereby forming a final version. The processing element is configured to send the final version to the user via the host server.

### BACKGROUND

Light emitting diode (LED) signs vary in pixel matrix and aspect ratio. Pixel matrix is the number of LEDs along the horizontal axis and the number of LEDs along the vertical axis. Aspect ratio is the ratio between the width and the height of the LED sign. To display content on a particular LED sign, the format of the content must be compatible with the specific pixel matrix and aspect ratio of the LED sign, otherwise the content will appear warped, pixelated, or distorted on the LED sign. Thus, selected images and other content must be formatted to properly fit each LED sign. To format the content for a sign, a user must either buy expensive software tools to manually format the content and/or hire professional graphic designers to generate and/or format the content for the user. If the user wants to use an image from the internet for loading on the sign, the user must download the image and then use the software tools to format it or send it to the professional graphic designer for formatting. These formatting problems are even greater for animations. Many users have multiple LED signs with different pixel matrices and aspect ratios and therefore must have the content formatted for each LED sign. Thus, it is expensive and time-consuming for users to have desired content generated or modified to be compatible with their LED signs.

The background discussion is intended to provide information related to the present invention which is not necessarily prior art.

### SUMMARY

The present invention solves the above-described problems and other problems by providing a distinct advance in the art of generating and customizing content for LED signs. More particularly, the present invention provides a system and method for generating customized content for LED signs that enables a user to select the content and have it automatically customized to fit their particular LED sign.

A system constructed according to one embodiment of the present invention broadly includes a database, a host server, and a processing element. The database stores a plurality of templates of digital content for LED signs. At least one of the templates has a plurality of versions, with each version of the template having a different aspect ratio.

The host server is coupled to the database and is configured to host a user interface that may be accessed by owners and/or designers of LED signs. The user interface displays the plurality of templates and that receives information from the user.

The processing element is coupled to the host server and is configured to receive from the user a selection of a selected template, receive from the user the dimensions of the user's LED sign, determine an optimum version of the selected template based on the dimensions of the user's LED sign, crop the optimum version to match an aspect ratio of the dimensions of the user's LED sign thereby forming a cropped version, size the cropped version to match the dimensions of the user's LED sign thereby forming a sized version, and transmit the sized version to the user so that the user may load the sized version onto the user's LED sign.

A method for generating content for an LED sign according to an embodiment of the present invention broadly includes providing access to a user interface on a server coupled to a database having a plurality of selectable templates of content for LED signs. At least one of the templates has a plurality of versions, with each version of the template having a different aspect ratio. A selection of a selected template is received via the user interface. Desired dimensions for a user's LED sign are received via the user interface. An optimal version of the selected template is selected based on the desired dimensions. The optimal version is cropped to match an aspect ratio of the desired dimensions thereby forming a cropped version. The cropped version is sized to match the desired dimensions thereby forming a sized version, and the sized version is transmitted to the user so that the user may load the sized version onto the user's LED sign.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic view of a system constructed in accordance with an embodiment of the present invention.

FIG. 2 is a schematic view of a system constructed in accordance with another embodiment of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

The present invention broadly concerns a system and method that resolve an internet-centric problem related to the generation of content for a light emitting diode (LED) sign. The system and method also improve a functioning of a database having content for LED signs stored thereon. The system broadly includes a memory element and a processing element coupled to the memory element. The memory element stores digital content thereon as templates. The templates may have multiple versions, wherein each version has a different aspect ratio. Each version maintains the important portions of the content, such as the focal point of an animation, the body of text, etc. This allows customization of digital content for an LED sign having any aspect ratio.

The processing element is configured to host a user interface that may display a single image for each template. The user interface is accessible to a user so that the user may select content and enter the dimensions of their LED sign. The processing element is further configured to automatically customize the selected content based on the dimensions of the user's LED sign and transmit the customized content to the user via the user interface. The automatic customization using the processing element improves the functioning of the database so that it is not required to store a version of each template for every possible aspect ratio of an LED sign. Further, customizing the content via the processing element for the user prior to transmitting the content to the user resolves the internet-centric problem of needing to format the content after downloading it from the internet and prior to loading it onto the user's LED sign.

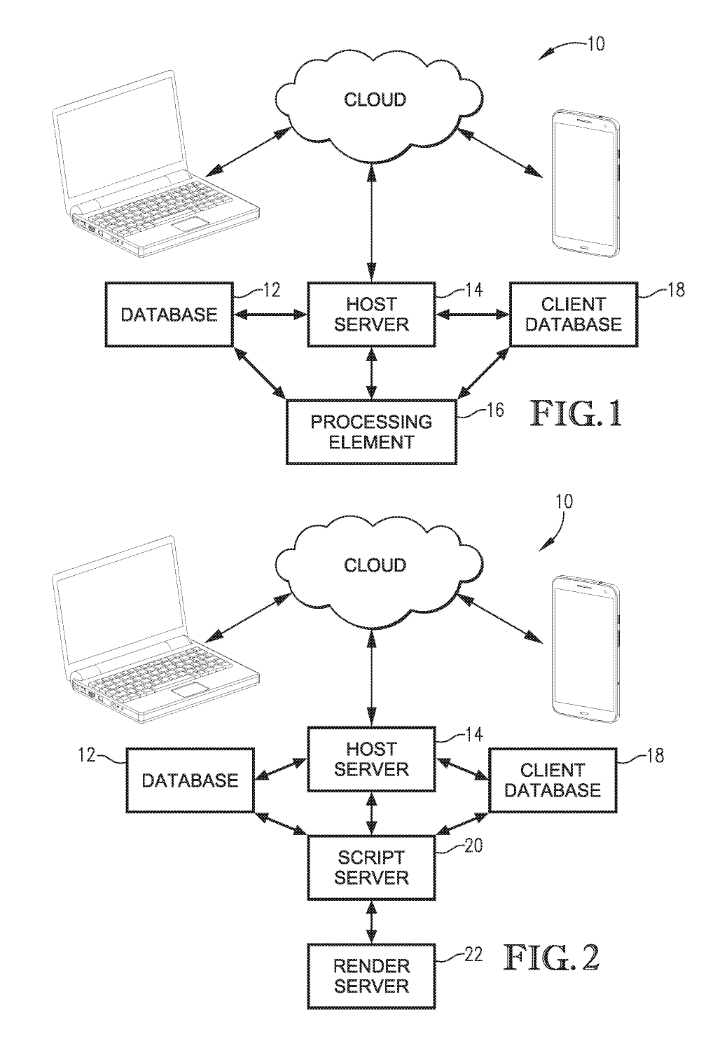

A system 10 constructed in accordance with a specific embodiment of the invention is illustrated in FIG. 1. The system 10 broadly includes a database 12, a host server 14 coupled to the database 12, and a processing element 16 coupled to the host server 14.

The database 12 may include one or more electronic hardware data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the database 12 may be embedded in, or packaged in the same package as, the host server 14 and/or processing element 16. The database 12 may include, or may constitute, a “computer-readable medium.” The database 12 may store instructions, code, code segments, software, firmware, programs, applications, apps, services, daemons, or the like that are executed by the host server 14 and/or the processing element 16.

The database 12 has stored thereon a plurality of templates of digital content for LED signs. The content includes images, videos, text, animations, and/or any combination thereof. At least one of the templates has a plurality of versions, and each version of the at least one template has a different aspect ratio. All the versions include the important portions of the content, such as the focal point of an animation, the main body of text, etc. This improves the functioning of the system and database so that the important portions of the content are not omitted or rendered unintelligible when cropped. The LED signs may be any kind of LED sign, including interior/exterior commercial LED signs, and they may utilize any type of technology including surface mount device (SMD), duel-in-line-package (DIP), organic LED (OLED), quantum dot (QD), and/or any other type known in the art.

The host server 14 is coupled to the database 12. Coupling as used herein and throughout may include communication via signal or data transmitting and receiving circuits, such as antennas, transceivers, amplifiers, filters, mixers, oscillators, digital signal processors (DSPs), and the like. Coupling may include establishing communication wirelessly by utilizing RF signals and/or data that comply with communication standards such as cellular 2G, 3G, 4G, 5G, or LTE, IEEE 802.11 standard such as WiFi, IEEE 802.16 standard such as WiMAX, Bluetooth®, Zigbee or combinations thereof. Alternatively, or in addition, coupling may be performed by establishing communication through connectors or couplers that receive metal conductor wires or cables which are compatible with networking technologies such as ethernet. In certain embodiments, the coupling may include systems with optical fiber cables.

The host server 14 is configured to host a user interface accessible to the user. The host server 14 may be embodied by one or more personal computers such as desktop workstations and/or laptop computers, and/or by application servers, database servers, file servers, web servers, or the like, or combinations thereof. Furthermore, the host server 14 may include a plurality of servers, virtual servers, or combinations thereof. The host server 14 may be configured to include or execute computer programs and software such as file storage applications, database applications, email or messaging applications, web server applications, or the like, in addition to and/or in conjunction with the computer program and/or software described elsewhere herein (e.g., the source application, the integration application, and/or the inflation application).

The user interface displays the plurality of templates pulled from the database 12 by the host server 14. The user interface may also receive information from the user. The information may include a selection of a selected template (such as a product stock keeping unit (SKU) associated with the selected template), dimensions of the user's LED sign (such as its height, width, aspect ratio, pixel matrix, etc.), a desired file type (such as PDF, JPEG, GIF, PNG, TIFF, BMP, MP4, WMV, MPEG-4, PX, or any other file type known in the art), and/or edits to be applied to the selected template. The edits may include desired changes to the text, font, color, animation speed, etc. The user interface may be a website or webpage accessed through an internet browser. The user interface may also be an application on a mobile device, such as a smart phone, tablet, laptop or the like, or the user interface may be an application on a desktop computer. The host server 14 may be configured to transmit the information from the user to the processing element 16. For example, the host server 14 may send the template's product SKU, the LED sign's dimensions, and the desired file type to the processing element 16. In some embodiments, the user interface may only be accessed by secured means, such as through a login portal. The host server 14 may be configured to require the user to enter their credentials (such as a username, password, biometric device reading, or the like) to login through the login portal.

The host server 14 is configured to receive from the processing element 16 a final copy of the content in the desired file type and transmit the content to the user. The user may download the content directly from the user interface, or the host server 14 may be configured to transmit the content to the user via email or deposit the content in a file-sharing, online repository, or other type of repository.

The processing element 16 is coupled to the host server 14 and is configured to automatically customize the selected template. The processing element may include processors, microprocessors, microcontrollers, DSPs, field-programmable gate arrays (FPGAs), analog and/or digital application-specific integrated circuits (ASICs), or the like, or combinations thereof. The processing element 16 may generally execute, process, or run instructions, code, code segments, software, firmware, programs, applications, apps, processes, services, daemons, or the like. The processing element 16 may also include hardware components, such as finite-state machines, sequential and combinational logic, and other electronic circuits that may perform the functions necessary for the operation of embodiments of the current inventive concept. The processing element 16 may be coupled with the other electronic components through serial or parallel links that include address busses, data busses, control lines, and the like. The processing element 16 may be embedded in the database 12 or the host server 14, or may be an entirely different server, or network of servers.

The processing element 16 is configured to receive from the host server 14 the selection of the selected template and the dimensions of the user's LED sign. This may be the template's SKU, a hash code representative of the storage location of the template on the database 12, a name of the template, or any information about the template that would aid the processing element 16 in finding the selected template on the database 12, or the like. The processing element 16 is configured to determine an optimum version of the selected template based on the dimensions of the user's LED. The processing element 16 may be configured to calculate the aspect ratio of the LED sign based on the height and width received from the user, or the processing element 16 may receive the aspect ratio from the user via the host server 14. The processing element 16 may be configured to conduct a search of the database 12 to determine which aspect ratios are available for the selected template. For example, the database 12 may already have stored thereon a list of the all the aspect ratios for the selected template, and the processing element 16 may be configured to retrieve that list. Alternatively, the processing element 16 may be configured to find the selected template in the database 12 and retrieve every aspect ratio of the versions for the selected template. The processing element 16 may be configured to compare the aspect ratio of the LED sign with the available aspect ratios for the template or otherwise implement an algorithm that determines the optimal version of the template based on the dimensions of the LED sign.

The processing element 16 is further configured to crop the optimum version of the template to match the aspect ratio of the LED sign. This may include cropping vertically or horizontally, depending on the dimension that needs to be reduced. This may include cropping the optimum version to form a particular shape. If the aspect ratio already matches, then the cropping may include just reducing the dimensions by 0, or a null crop. Alternatively, the cropping of the optimum version may include determining whether the optimum version's aspect ratio matches the LED sign's aspect ratio and then not reducing any dimensions of the optimum version if the optimum version's aspect ratio already matches. The cropping forms a cropped version of the optimum version, which the processing element 16 is configured to size to match the dimensions of the user's LED sign thereby forming a sized version of the cropped version. The sizing of the cropped version expands or reduces the height and the width proportionally so that the aspect ratio is preserved. The processing element 16 may be configured so that the sizing of the cropped version makes it so that the sized version has a pixel matrix that is the same as the user's LED sign. The processing element 16 is configured to transmit the sized version as the final copy to the user via the host server 14. Transmission includes making the sized version available for the user to download and/or save the sized version via the user interface hosted on the host server 14, or the host server 14 may be configured to email, text, or otherwise transmit the sized version to the user. Transmission may include depositing the sized version in a file-sharing, online repository, or other type of repository.

In some embodiments, the processing element 16 may also be configured to receive the desired file type and/or the edits to be applied to the selected template. The processing element 16 may be configured to apply the edits to the optimum version of the selected template thereby forming a final version. The processing element 16 may convert the final version into the desired file type and transmit it to the user via the host server 14.

In some embodiments, the system 10 may include a client database 18 coupled to the host server 14 and/or the processing element 16 for storing user information. The client database 18 may include one or more memory components similar to the database 12 and may include one or more server or processing element similar to the processing element 16. The host server 14 may be configured to store on the client database 18 the selections of the templates that the user makes, the dimensions of the user's LED sign, the desired file type, and/or the edits to be applied to the selected template. The host server 14 and/or the processing element 16 may be configured to generate and store a copy of the final copy customized for the user on the client database 18. The host server 14 may be configured so that the user can access the information and/or the copy of the final copy at a later time via the user interface.

For example, the user may access the client database 18 via the user interface to download the copy of the final copy at a later time. Or the user may access the copy of the final copy, submit new edits via the user interface, and then the processing element 16 may be configured to apply the new edits and transmit the newly edited version to the user.

The processing element 16 may be coupled to the client database 18 and be configured to analyze the information stored on the client database 18 to detect trends, such as trends in the selection of templates in relation to a time of year. The processing element 16 may also be configured to analyze the information on the client database 18 to generate a marketing profile for the user. The marketing profile may be a file having information associated with an internet protocol (IP) address associated with the user, or the user's login information. The marketing profile information may include the user's business type, size of business, spending history, template selections, shared attributes among the selected templates (color, subject matter, animation, theme, or the like), number of LED signs, LED sign types, LED sign dimensions, etc. The processing element 16 may be configured to determine trends with the user, such as a type of template usually selected and a time of year the type of template is selected by the user.

As shown in FIG. 2, the processing element 16 may include a script server 20 coupled to the host server 14 and a render server 22 coupled to the script server 20. The script server 20 and render server 22 may be constructed of one or more servers, similar to the host server 14. The servers 16, 20, 22 may communicate using any server protocol known in the art, including file transfer protocol (FTP), secure shell file transfer protocol (SSFTP), applicability statement 2 (AS2), hypertext transfer protocol secure (HTTPS), managed file transfer (MFT), trivial file transfer protocol (TFTP), simple file transfer protocol (SFTP), or the like.

The script server 20 may be coupled to the database 12, host server 14, client database 18, and the render server 22, and may be configured to receive from the database 12 and/or the host server 14 the selected template, the dimensions of the user's LED sign, and the edits to be applied to the template. The script server 20 calculates an aspect ratio for the user's LED sign based on the dimensions of the user's LED sign received from the host server 14. The script server 20 is configured to determine the optimum version of the selected template that has an aspect ratio closest to the aspect ratio for the user's LED sign. The script server 20 then generates a copy of the optimum version from the database 12 and transmits the edits to be applied to the template and the copy of the optimum version to the render server 22 in a file having a file format such as JavaScript Object Notation (JSON), extensible markup language (XML), MessagePack, yet another markup language (YAML), binary script object notation (BSON), or the like.

The render server 22 is coupled to the script server 20 and is configured to receive from the script server 20 the copy of the optimum version and the edits to be applied to the template. The render server 22 is configured to apply the edits to the optimum version of the selected template, thereby rendering an edited copy and transmit the edited copy to the script server 20. The script server 20 is configured to receive the edited copy from the render server 22, crop the edited version to match the aspect ratio of the user's LED sign thereby forming the cropped copy, size the cropped copy to match the dimensions of the user's LED sign thereby forming the final copy, and transmit the final copy to the host server 14. The script server 20 may also be configured to transmit a final copy of the final copy to the client database 18.

In use, the system 10 is provided so that the user may access the user interface hosted by the host server 14 via an internet browser or application on a smart phone, tablet, computer, etc. The user selects a selected template having an SKU, provides the dimensions of the user's LED sign, indicates a desired file type, and provides the edits to be applied to the template via the user interface. The host server 14 receives via the user interface the selection of the selected template, the dimensions of the user's LED sign, the desired file type, and the edits to be applied to the template, and sends them to the processing element 16 and the client database 18. The processing element 16 calculates the aspect ratio of the user's LED sign and determines the optimum version of the selected template based on the dimensions of the user's LED sign. The processing element 16 applies the edits to the optimum version thereby rendering an edited version, crops the edited version thereby forming a cropped version, and sizes the cropped version thereby forming a sized version. The processing element then converts the sized version to the desired file type thereby forming the final copy and sends the final copy to the host server 14. The processing element 16 also sends a copy of the final copy to the client database 18. The host server 14 sends the final copy to the user via the user interface so that the user may download the final copy and load the content onto the user's LED sign.

In some alternative implementations, the functions described above may occur out of the order in which they were listed. For example, two functions may in fact be executed substantially concurrently, or the functions may sometimes be executed in the reverse order depending upon the functionality involved.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A system having a processor configured for automatic formatting of digital content for LED signs to dimensions of an LED sign prior to transmitting the digital content to a user, the system comprising:
a database having stored thereon a plurality of templates of digital content for LED signs, one template having a plurality of versions, one version of the template having a different aspect ratio and a focal point;
a host server coupled to the database and having a user interface that displays the plurality of templates and that receives information from the user;
the processor being coupled to the database and configured to—
receive from the user interface a selection of a selected template,
receive from the user interface a pixel matrix of the LED sign,
automatically determine an optimum version of the selected template based on the pixel matrix of the LED sign,
automatically crop the optimum version to match an aspect ratio of the LED sign and maintain the focal point of the optimum version, thereby forming a cropped version,
automatically size the cropped version to match the pixel matrix of the LED sign thereby forming a sized version, and
transmit the sized version to the user so that the user may load the sized version onto the LED sign.

2. The system of claim 1, wherein the user interface receives from the user a selection of a selected file type and the processor is configured to convert the sized version to the selected file type before transmitting to the user.

3. The system of claim 1, the user interface further including an editing user interface that receives from the user edits to be applied to the template, wherein the processor is configured to—
receive from the user interface edits to be applied to the template; and
apply the edits to the optimum version of the selected template.

4. The system of claim 3, wherein the processor includes
a script server coupled to the host server and configured to perform the sizing and cropping; and
a render server coupled to the script server and is configured to apply the edits to the optimum version of the selected template.

5. The system of claim 1, wherein the user interface is a website accessible by the user via an internet browser.

6. The system of claim 1, further comprising a client database coupled to the host server configured to receive and store data related to selections made on the user interface.

7. The system of claim 6, wherein the processor is coupled to the client database and configured to process the data related to selections made on the user interface to detect trends.

8. The system of claim 6, wherein the processor is coupled to the client database and configured to process the data related to selections made on the user interface to create a marketing profile for the user.

9. The system of claim 1, wherein the user interface is a mobile device application.

10. The system of claim 1, wherein the LED sign is a DIP type LED sign.

11. The system of claim 1, wherein the LED sign is an SMD type LED sign.

12. The system of claim 1, further including a client database coupled to the host server for receiving and storing a copy of the sized version.

13. The system of claim 12, wherein the host server is configured to allow the user to copy and download via the user interface the copy of the sized version stored on the client database.

14. A computer-implemented method for generating content for an LED sign:
providing access to a user interface on a server coupled to a database having a plurality of selectable templates of content for an LED sign, one template on the database having a plurality of versions, one version of the template having a different aspect ratio and a focal point;
receiving a selection of a selected template via the user interface;
receiving an LED pixel matrix of the LED sign via the user interface;
selecting an optimal version of the selected template based on the LED pixel matrix of the LED sign;
cropping the optimal version to match an aspect ratio of the LED pixel matrix of the LED sign and maintain the focal point of the optimal version, thereby forming a cropped version;
sizing the cropped version to match the LED pixel matrix of the LED sign thereby forming a sized version; and
transmitting the sized version to the user so that the user may load the sized version onto the LED sign.

15. The method of claim 14, including receiving a selection of a selected file type and converting the sized version to the selected file type.

16. The method of claim 14, including
providing an editing user interface that receives edits for the selected template, and
applying the edits for the selected template to the optimal version of the selected template.

17. The method of claim 14, including storing information related to the selections received from the user interface on a client database, and processing the information related to the selections received from the user interface on the client database for determining trends and generating a marketing profile for the user.

18. The method of claim 14, including storing a copy of the sized version on a client database so that the user may access the copy of the sized version at a later time.

19. A system having a processor configured for automatic formatting of digital content for LED signs to an LED pixel matrix of an LED sign prior to transmitting the digital content to the user, the system comprising:
a database having a plurality of templates of digital content stored thereon, one template having multiple versions, one version having a different aspect ratio and focal point;
a host server coupled to the database and having a processor configured to—
host a website having a user interface that
displays the plurality of templates,
receives from the user a selection of a selected template and the LED pixel matrix of the LED sign,
receives from the user edits to be applied to the selected template, and
receive a final copy and transmit the final copy to the user so that the user may load the sized version onto the LED sign;
a script server coupled to the database and the host server, the script server having a second processor configured to—
receive from the host server the selection of the selected template,
receive from the host server the LED pixel matrix of the LED sign,
receive from the host server the edits to be applied to the selected template,
automatically calculate an aspect ratio for the LED sign based on the LED pixel matrix of the LED sign,
automatically determine an optimum version of the selected template that has an aspect ratio closest to the aspect ratio of the LED sign,
automatically generate a copy of the optimum version of the selected template from the database,
receive an edited copy,
automatically crop the edited copy to match the desired aspect ratio and maintain the focal point, thereby forming a cropped copy,
automatically size the cropped copy to match the LED pixel matrix thereby forming the final copy, and
transmit the final copy to the host server; and
a render server coupled to the script server and having a third processor configured to—
receive from the script server the copy of the optimum version,
receive from the script server the edits to be applied to the selected template,
apply the edits to the copy of the optimum version of the selected template thereby forming an edited copy, and
transmit the edited copy to the script server.

20. The system of claim 19, the processor of the host server configured to store on the database a copy of the final copy for later access by the user.
